(19) United States
(12) Patent Application Publication
(10) Pub. No.: US 2007/0093922 A1
(43) Pub. Date: Apr. 26, 2007

(54) Music-playing continuing device of a digital audio signal player

(76) Inventors: Shen-Chi Liu, Tainan City (TW); Chin-Chen Ho, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/258,070

(22) Filed: Oct. 26, 2005

(51) Int. Cl. G06F 17/00

(52) U.S. Cl. 700/94

(57) ABSTRACT

A digital audio signal player includes a CD support seat for holding a CD, a microprocessor, a laser pick-up, and a dynamic RAM; a CD supported on the CD support seat will rotate several times the normal speed, and the laser pick-up will read the CD when the microprocessor starts functioning; when the laser pick-up reads a CD, data of the CD will be transferred to and stored into the dynamic RAM; the dynamic RAM is divided into first and second sections, which are respectively used for storing music, which is currently being played, and for storing music that is to be played immediately after the current music is finished; therefore, the first and the second sections of the dynamic RAM can take turns to store music of different compact disks, thus preventing interruption of music playing from happening owing to a change of CD.

### BACKGROUND OF THE INVENTION

1. Field of the invention

The present invention relates to a music-playing continuing device of a digital audio signal player, more particularly one, which allows the user to change from one CD to another without causing interruption of music-playing by the digital audio signal player.

2. Brief Description of the Prior Art

In order to help enhance the atmosphere in a music show or a dancehall, the DJ usually makes the music played with scratch sound effects by means of manually moving the analogue vinyl record positioned on the turntable at changing speeds and in alternate directions. As soon as the DJ stops moving the record with his hands, the record player will start playing the record in the normal way again. However, a single analogue vinyl record has very limited capacity to store music in, and a DJ has to prepare a lot of vinyl records in every event, and the records are likely to cause the DJ inconvenience due to the large size and heavy weight.

In order to overcome the above problems, referring to FIG. 2, the inventor of the present invention taught a digital audio signal player, which includes a driving IC 1, a CD driving motor 11, a CD support seat 12, an ejection motor 13, a laser pick-up 14, a laser pick-up moving motor 15, a microprocessor 2, a control panel 21, a high frequency amplifier 3, a CD digital processor 4, a digital audio signal processor 5, a dynamic random access memory (RAM) 51, a digital/analog converter 6, and a low pass filter 7.

The CD support seat 12 is provided for holding a CD, and connected to the CD driving motor 11. The driving IC 1 is electrically connected to both the CD driving motor 11 and the ejection motor 13 for activating the same; when activated, the CD driving motor 11 will turn a CD on the CD support seat 12, and the ejection motor 13 will eject the CD support seat 12 for allowing CD replacement.

When the microprocessor 2 is activated, it will make the high frequency amplifier 3 send out laser light, and make the CD digital processor 4 activate the laser pick-up 14 through the driving IC 1. The driving IC 1 will also activate the laser pick-up moving motor 15 to move the laser pick-up 14. And, the laser pick-up 14 will send a signal to the CD digital processor 4 via the high frequency amplifier 3, and the CD digital processor 4 will inform the microprocessor 2 whether the laser light has focused; if the laser light fails to focus, the microprocessor 2 will stop; if the laser light has focused successfully, the microprocessor 2 will activate the CD digital processor 4, and in turn the driving IC 1 will make the CD driving motor 11 function such that the CD positioned on the CD support seat 12 is rotated at several times the normal speed. Next, the laser pick-up 14 will read the data of the CD, and send the data to both the microprocessor 2 and the digital audio signal processor 5 via the high frequency amplifier 3 and the CD digital processor 4; thus, the digital audio signal processor 5 will store the data of the CD into the dynamic RAM 51. And, the microprocessor 2 will also make the control panel 21 show information about the music contents of the CD.

To play music with the digital audio signal player, the digital audio signal processor 5 will transfer the data stored in the dynamic RAM 51 to the digital/analog converter 6 such that the data are converted into analogous ones. Next, the analogous data are transferred through the low pass filter 7, and played. To produce scratch sound effects, which are similar to those produced when a vinyl record is manually rotated, with the digital audio signal player, the user should choose a music item to be played through the control panel 21, and he should set intended speed and rotational direction of music-playing by means of operating the control panel 21; thus, the data stored in the dynamic RAM 51 will be transferred to the digital/analog converter 6 according to the speed and rotational direction as set through the control panel 21. And, the chosen music item will be played and with scratch sound effects.

However, music player will be interrupted when the user changes from the currently used CD to a new one, and starts making the digital audio signal player read the new CD to store data into the dynamic RAM 51. In order to avoid interruption in playing music, it is common practice for DJ to buy and use two digital audio signal players of the kind instead of one, and connect both to a sound mixer. Therefore, the above digital audio signal player isn't economical to use.

### SUMMARY OF THE INVENTION

It is a main object of the invention to provide an improvement on a digital audio signal player to overcome the above-mentioned problem. The digital audio signal player of the present invention includes a CD support seat for holding a CD, a microprocessor, a laser pick-up, and a dynamic RAM. A CD supported on the CD support seat will rotate several times the normal speed, and the laser pick-up will read the CD when the microprocessor starts functioning. When the laser pick-up reads a CD, data of the CD will be transferred to and stored into the dynamic RAM. The dynamic RAM is divided into first and second sections, which are respectively used for storing music, which is currently being played, and for storing music that is to be played immediately after the current music is finished. Therefore, the first and the second sections of the dynamic RAM can take turns to store music of different compact disks, thus preventing interruption of music playing from happening owing to a change of CD.

### BRIEF DESCRIPTION OF THE DRAWINGS

The present invention will be better understood by referring to the accompanying drawings, wherein:

FIG. 1 is a circuit block diagram of the digital audio signal player in the present invention, and

FIG. 2 is a circuit block diagram of the currently existing digital audio signal player as described in Background.

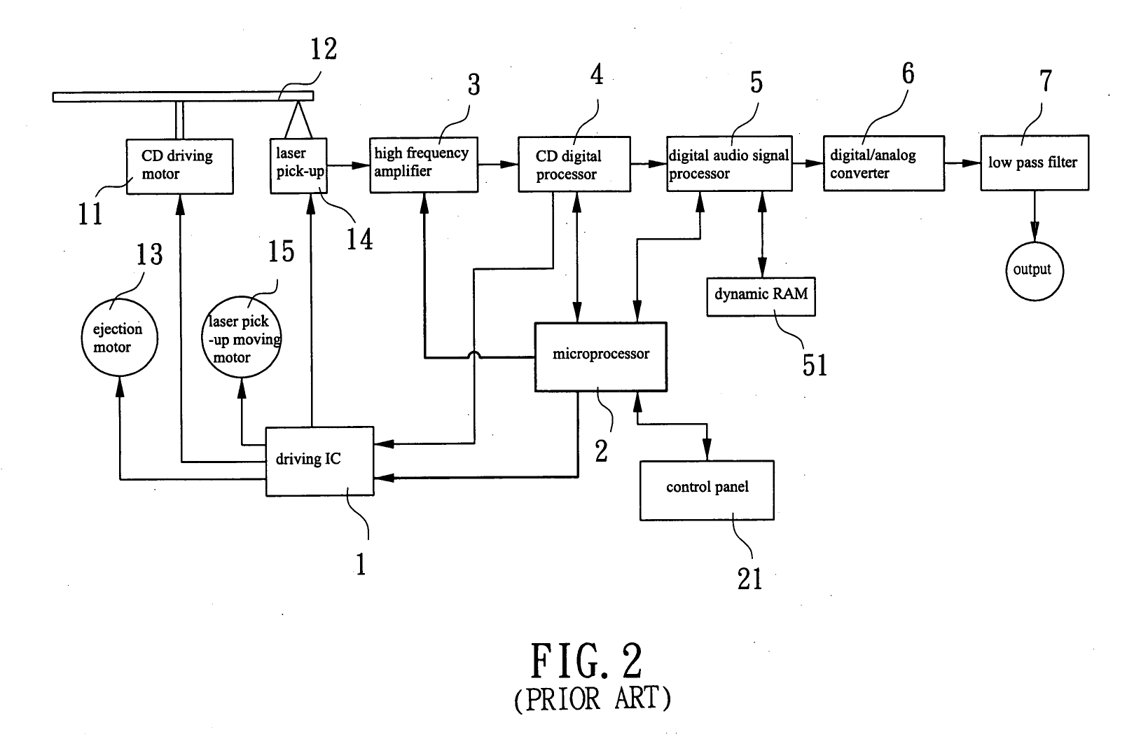

### DETAILED DESCRIPTION OF THE PREFERRED EMBODIMENTS

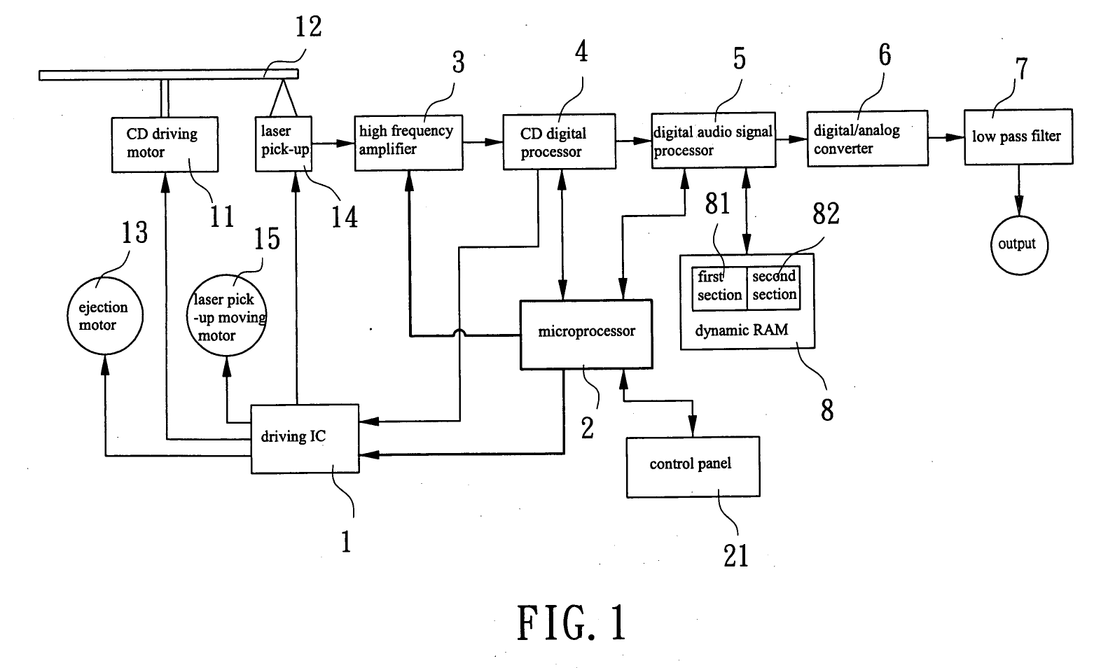

Referring to FIG. 1, a preferred embodiment of a digital audio signal player of the invention includes a driving IC 1, a CD driving motor 11, a CD support seat 12, an ejection motor 13, a laser pick-up 14, a laser pick-up moving motor 15, a microprocessor 2, a control panel 21, a high frequency amplifier 3, a CD digital processor 4, a digital audio signal processor 5, a dynamic RAM 8, a digital/analog converter 6, and a low pass filter 7.

The CD support seat 12 is provided for holding a CD, and connected to the CD driving motor 11. The driving IC 1 is electrically connected to both the CD driving motor 11 and the ejection motor 13 for activating the same; when activated, the CD driving motor 11 will turn a CD on the CD support seat 12, and the ejection motor 13 will eject the CD support seat 12 for allowing change of CD. The dynamic RAM 8 is divided into first and second sections 81 and 82.

When the microprocessor 2 is activated, it will make the high frequency amplifier 3 send out laser light, and make the CD digital processor 4 activate the laser pick-up 14 through the driving IC 1. The driving IC 1 will also activate the laser pick-up moving motor 15 to move the laser pick-up 14. And, the laser pick-up 14 will send a signal to the CD digital processor 4 via the high frequency amplifier 3, and the CD driving motor 11 will start functioning such that the CD positioned on the CD support seat 12 is rotated at several times the normal speed. Next, the laser pick-up 14 will read the data of the CD, and send the data to both the microprocessor 2 and the digital audio signal processor 5 via the high frequency amplifier 3 and the CD digital processor 4; thus, the digital audio signal processor 5 will store the data of the CD into the first section 81 of the dynamic RAM 8. And, the microprocessor 2 will also make the control panel 21 show information about the music contents of the CD.

To play music with the digital audio signal player, the digital audio signal processor 5 will transfer the data stored in the first section 81 of the dynamic RAM 8 to the digital/analog converter 6 such that the data are converted into analogous ones. Next, the analogous data are transferred through the low pass filter 7, and played. To produce scratch sound effects, which are similar to those produced when a vinyl record is manually rotated, with the digital audio signal player, the user should choose a music item to be played through the control panel 21, and he should set a intended speed and rotational direction of music-playing by means of operating the control panel 21; thus, the data stored in the first section 81 of the dynamic RAM 8 will be transferred to the digital/analog converter 6 according to the speed and rotational direction as set through the control panel 21. And, the chosen music item will be played and with scratch sound effects.

When the digital audio signal player is reading certain music items chosen from the current CD, and storing them in the first section 81 of the dynamic RAM 8, and the user wants to change to certain music items chosen from a second CD, he should replace the current CD with the second one when the audio signal player indicates that the last one of the chosen music items from the current CD has been read and stored, and the length of those music items that have been stored into the first section 81 of the dynamic RAM 8 and not yet played is so long that interruption of music playing won't happen owing to the change of CD. In other words, the length of those music items that have been stored into the first section 81 of the dynamic RAM 8 and not yet played is so long that the user can finish replacing CD and storing at least the first one of music items chosen from the second CD into the second section 82 before the digital audio signal player finishes playing the last one of the chosen music items, which is from the first CD and stored in the first section 81 of the dynamic RAM 8.

When the digital audio signal player is storing certain music items chosen from the second CD into the second section 82 of the dynamic RAM 8, the user is allowed to replace the second CD with a third one when the audio signal player indicates that storage of the last one of the chosen music items of the second CD has been finished, and the length of those music items that have been stored in the second section 82 of the dynamic RAM 8 and not yet played is so long that interruption of music playing won't happen owing to change of CD. In other words, the length of those music items that have been stored in the second section 82 of the dynamic RAM 8 and not yet played is so long that the user can finish changing CD and storing at least the first one of music items chosen from the third CD into the first section 81 before the digital audio signal player finishes playing the last one of the chosen music items, which is from the second CD and stored in the second section 82 of the dynamic RAM 8.

Therefore, when the digital audio signal player of the present invention is playing CD, the user is allowed to change from one CD to another without causing interruption of music-playing. From the above description, it can be easily seen that the present digital audio signal player is more convenient to use than the prior art as described in the Background.

What is claimed is:

1. A music-playing continuing device of a digital audio signal player, comprising
a CD support seat for holding a CD;
a microprocessor;
a laser pick-up; a CD supported on the CD support seat being going to rotate a plurality of times a normal speed, and the laser pick-up being going to read the CD when the microprocessor starts functioning; and
a dynamic RAM; when the laser pick-up reads a CD, data of the CD being going to be transferred to and stored into the dynamic RAM;
the dynamic RAM being divided into first and second sections, which are respectively used for storing music, which is currently being played, and for storing music that is to be played immediately after the current music is finished;
whereby the first and the second sections of the dynamic RAM can take turns to store music, thus preventing interruption of music playing from happening owing to a change of CD.
